(19) United States
(12) Patent Application Publication
(10) Pub. No.: US 2006/0034148 A1
(43) Pub. Date: Feb. 16, 2006

(54) High speed mixer

(76) Inventors: Michael R. Shaffer, Sidney, OH (US); Michael Hayden, Sidney, OH (US); Chris Tatarian, Troy, OH (US)

Correspondence Address: HARNESS, DICKEY & PIERCE, P.L.C., P.O. BOX 828, BLOOMFIELD HILLS, MI, 48303, US

(21) Appl. No.: 11/201,469

(22) Filed: Aug. 11, 2005

Related U.S. Application Data
(60) Provisional application No. 60/601,717, filed on Aug. 13, 2004.

(51) Int. Cl. A21C 1/06

(52) U.S. Cl. 366/99; 366/185

(57) ABSTRACT

A high-speed mixer includes an open frame structure having a bowl tiltably supported therein. A drive assembly is cantilevered from one end of the open frame structure and directly couples to an agitator rotatable supported in the bowl. The drive assembly is sufficiently self-enclosed to afford the use of an open frame construction without additional enclosures to prevent contamination and facilitate sanitation.

### CROSS-REFERENCE TO RELATED APPLICATIONS

This application claims the benefit of U.S. Provisional Application No. 60/601,717 filed on Aug. 13, 2004. The disclosure of the above application is incorporated herein by reference.

### FIELD OF THE INVENTION

The present invention relates to a dough mixer, and more particularly to an open-frame, direct-drive high speed mixer for preparing dough and batters.

### BACKGROUND OF THE INVENTION

Dough mixers typically fall into one of three categories spiral mixers, vertical mixers, and, horizontal mixers. Large commercial and wholesale bakeries utilize horizontal batch mixers which provide a flexible, cost-effective and reliable means for mixing. Horizontal mixers have an elongated mixing chamber disposed generally horizontally with respect to the ground surface by a frame. An elongated, horizontal mixing shaft with mixing arms or blades extending therefrom rotates around the inside of the mixing chamber. The horizontal mixing shaft extends out of the chamber at both ends of the mixing chamber and is supported for relative rotation movement on bearings. A drive mechanism including a chain or belt couples the shaft to a motor for rotating the mixing shaft on the mixing chamber. The drive mechanism may drive one end of the mixing shaft or at both ends of the mixing shaft with a synchronous drive mechanism. An indirect drive mechanism as describe above has certain inherent power losses associated therewith.

An indirect drive as described above also requires that the chain or belt in the drive mechanism be properly set up and maintained to ensure efficient operation. Specifically, the chain or belt must be tensioned for transmitting the necessary torque to rotate the mixing shaft. In may be necessary to provide a tensioner in the drive mechanism to maintain proper tension. Likewise, the various components in the drive mechanism must be periodically lubricated. As such, conventional belt or chain driven mixer can present set-up and maintenance tasks.

Furthermore, in the food industry the complexity of the machinery directly affects the sanitation of the mixer. For this reason, the mixer, and in particular the various drive components are concealed in a covered enclosure to prevent contamination of the food products being mixed in the mixing chamber, as well as to prevent dough ingredients from dirtying the drive mechanism. While the enclosure functions sufficiently in this regard, it complicates the process for cleaning and sanitizing the mixer.

### SUMMARY OF THE INVENTION

In accordance with the present teachings, a high-speed mixer is provided which includes an open frame structure and a drive assembly directly coupled to an agitator rotatable supported in a bowl without the use of chains or belts. The drive assembly is sufficiently self-enclosed to afford the use of an open frame construction without additional enclosures to prevent contamination and facilitate sanitation.

Further areas of applicability of these teaching will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevation of the high speed mixer shown in FIG. 1;

FIG. 2 is a top plan view of the high speed mixer shown in FIG. 1;

FIG. 3 is an end elevation of the high speed mixer shown in FIG. 1 showing the mixing bowl in an upright position; and

FIG. 4 is an end elevation of the high speed mixer showing the mixing bowl in a tipped or tilted position.

### DETAILED DESCRIPTION

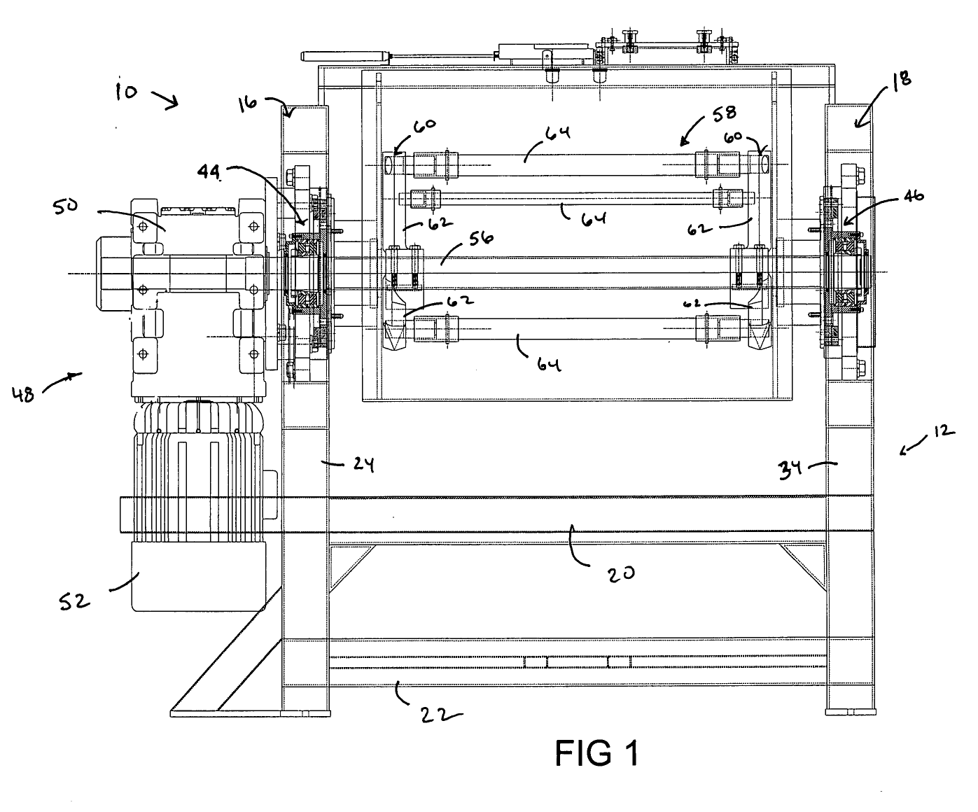

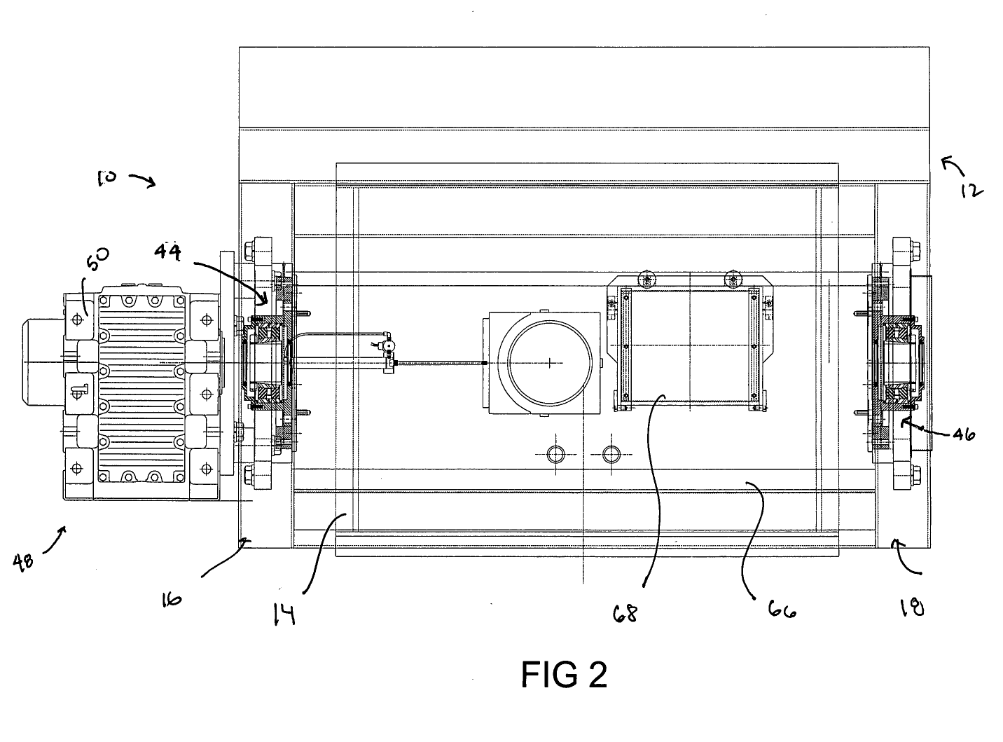

The following detailed description is merely exemplary in nature and is in no way intended to limit the claimed invention, its application, or uses. With reference now to the drawings, a high-speed horizontal mixer 10 well-suited for use to make batter and yeast dough for baked goods such as bagels, bread, bums, muffins, pizza crust, rolls and tortilla shells is illustrated. The mixer 10 includes an open frame structure 12 which supports the bowl 14. The bowl 14 is supported in frame structure 12 at bearing assemblies 16. The bowl 14 is rotatably supported for movement through more than ninety degrees from an upright position, as shown in FIGS. 1-3, for loading and mixing and a dumped or tilted position, as shown in FIG. 4, for unloading the dough for subsequent processing. The bowl 14 may optionally be equipped with a stainless steel refrigeration jacket to provide a cooling function during the mixing operation.

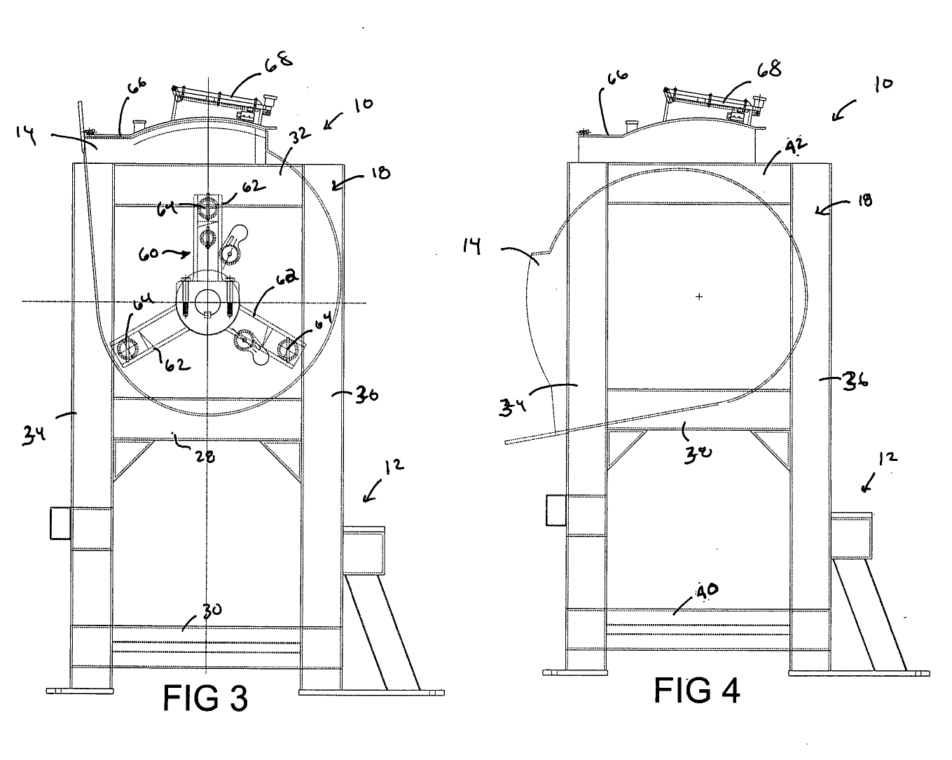

Referring now to FIG. 1, the frame structure 12 includes a pair of uprights 16, 18 transversely spaced apart by cross-members 20, 22. In this manner, the uprights 16, 18 define an open central region above the cross-member 20 where the bowl 14 is supported. Upright 16 includes a pair of posts 24, 26 laterally spaced apart by supports 28, 30, 32. Similarly, upright 18 includes a pair of posts 34, 36 laterally spaced apart by supports 38, 40, 42. A support leg 44 extends downwardly and outwardly from cross-member 20 and outwardly from upright 16 for transversely stabilizing the frame structure 12. As shown in FIGS. 3 and 4, support legs 46 (one shown) extend downwardly from cross-member 20 and outwardly from uprights, 16, 18 at the back of the open frame structure 12 for laterally stabilizing the frame structure 12. The open frame structure 12 is such that the front of the mixer 10 is substantially free of transverse support structures, thereby enabling quick and easy sanitation and maintenance of both the machinery and the surrounding floor/support structure.

As stated above, the bowl 14 is supported from the uprights 16, 18 by bearing assemblies 44, 46 which enable the bowl to be rotated between upright and tilted positions. Bearing assemblies 44, 46 are secured to the uprights 16, 18 supported above the supports 30, 40.

A direct drive assembly 48 including a reducer assembly 50 is cantilevered from the frame structure 12 outside of upright 16. A motor 52 is vertically mounted to the upright 16 such that a motor shaft is extends into the bottom of the reducer assembly 50 and couples to the input side thereof. The output side of the reducer assembly 50 is directly coupled to the horizontal shaft 56 of an agitator 58. In this manner the drive assembly 48 provides a single end direct drive mechanism without requiring additional drive chains or belts. Furthermore, the reducer mechanism provides power transmission from an input that is oriented 90° relative to the output, thereby providing a compact packaging of the direct drive assembly 48 at one of the mixer 10. As presently preferred, motor 52 is a 2 speed TEFC motor with SMC high torque design, but could alternately be an inverter duty TEFC motor or single speed motor. The reducer assembly 50 and the motor 52 are self-enclosed and do not require additional housing to provide adequate sanitation.

As best seen in FIGS. 1 and 3, the agitator 58 is a split hub agitator having a pair of hubs 60 located at each end of the agitator shaft 56. A set of arms 62 extend radially from the shaft 56 to support a roller bar 64 at the end thereof. As present preferred, the agitator 58 includes three roller bars 64 which are positioned and rotate within the bowl 14 for mixing product therein. One or more breaker bars (not shown) may also be employed on the agitator 58 or in the bowl 14.

The agitator shaft 56 is rotatably supported by bearing assemblies 44, 46. In this regard, each bearing assemblies 44, 46 provide a pair of concentric bearing mechanisms having a first bearing mechanism rotatably supporting the agitator shaft 56 and a second bearing mechanism rotatable supporting the bowl 14.

In an optionally preferred arrangement, a canopy or shroud 66 is supported on the top of the frame structure 12 and includes a flour gate assembly 68 above the bowl 14. The canopy 66 covers the opening of the bowl 14 when in the upright position but does not otherwise enclose the frame structure 12. The flour gate assembly 68 provides a closable aperture through which raw products used in the dough recipe can be loaded into the bowl 14. Other ingredient inlets and features can be provided as necessary. As presently preferred the frame structure 12, bowl 14, agitator 58 and the canopy 66 are fabricated from stainless steel. The direct drive assembly 48 is fabricated from heavy duty materials to provide continuous, reliable service and production.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A high speed mixer comprising:
an open frame structure having a pair of uprights transversely spaced apart by a cross-member to define an open central region above said cross-member;
a bowl tiltably supported by said pair of uprights in said open central region, said bowl having an opening which is positionable from an upright position to a tilted position;
an agitator horizontally supported in said bowl for relative rotation therein; and
a direct drive assembly cantilevered from one of said pair of uprights on a side opposite said open central region, said direct drive assembly including a vertically oriented drive motor and a reducer mechanism operably coupling said vertically oriented drive motor to an end of said agitator.

2. The high speed mixer of claim 1 further comprising a bearing assembly secured to each of said pair of uprights for tiltably supporting said bowl above said cross-member.

3. The high speed mixer of claim 2 wherein each of said bearing assemblies comprise a concentric bearing assembly having a first bearing mechanism rotatably supporting said agitator shaft and a second bearing mechanism rotatably supporting said bowl.

4. The high speed mixer of claim 3 wherein each of said bearing assemblies comprises a bearing cap secured thereto for enclosing said first and second bearing mechanisms.

5. The high speed mixer of claim 1 wherein each of said pair of uprights comprises a pair of posts laterally spaced apart by a plurality of supports to define an H-shaped upright.

6. The high speed mixer of claim 1 further comprising a transverse support leg extending downward from said cross member and transversely outward from said one of said pair of uprights beneath said direct drive assembly.

7. The high speed mixer of claim 1 further comprising a lateral support leg extending downward from said cross member and laterally outward from said open frame structure.

8. The high speed mixer of claim 7 wherein said lateral support leg extends outwardly from said open frame structure on a side opposite the location of said opening of said bowl in said tilted position.

9. The high speed mixer of claim 1 further comprising a canopy extending between said pair of uprights above said open central region which covers said opening of said bowl in said upright position.

10. A high speed mixer comprising:
an open frame structure including:
a pair of uprights having a pair of posts laterally spaced apart by a plurality of lateral supports to define an H-shaped upright;
a cross-member extending between and to transversely space said pair of uprights for defining an open central region above said cross-member;
a transverse support leg extending downward from said cross member and transversely outward from one of said pair of uprights; and
a lateral support leg extending downward from said cross member and laterally outward from said open frame structure;
a bowl tiltably supported by said pair of uprights in said open central region, said bowl having an opening which is positionable from an upright position to a tilted position;
an agitator horizontally supported in said bowl for relative rotation therein; and
a direct drive assembly cantilevered from said one of said pair of uprights on a side opposite said open central region and above said transverse support leg, said direct drive assembly including a vertically oriented drive motor and a reducer mechanism operably coupling said vertically oriented drive motor to an end of said agitator.

11. The high speed mixer of claim 10 wherein said lateral support leg extends outwardly from said open frame structure on a side opposite the location of said opening of said bowl in said tilted position.

12. The high speed mixer of claim 10 further comprising a bearing assembly secured to each of said pair of uprights for tiltably supporting said bowl above said cross-member.

13. The high speed mixer of claim 12 wherein each of said bearing assemblies comprise a concentric bearing assembly having a first bearing mechanism rotatably supporting said agitator shaft and a second bearing mechanism rotatably supporting said bowl.

14. The high speed mixer of claim 13 wherein each of said bearing assemblies comprises a bearing cap secured thereto for enclosing said first and second bearing mechanisms.

15. The high speed mixer of claim 10 further comprising a canopy extending between said pair of uprights above said open central region which covers said opening of said bowl in said upright position.
